(19) United States
(12) Patent Application Publication
(10) Pub. No.: US 2023/0210300 A1
(43) Pub. Date: Jul. 6, 2023

(54) MULTI-USE PORTAFILTER

(71) Applicants: Adel Wahhas, Springfield, MA (US); Jad Mourad, Springfield, MA (US)

(72) Inventors: Adel Wahhas, Springfield, MA (US); Jad Mourad, Springfield, MA (US)

(21) Appl. No.: 17/566,251

(22) Filed: Dec. 30, 2021

(51) Int. Cl. A47J 31/36; A47J 31/40; A47J 31/06

(52) U.S. Cl. CPC A47J 31/3695; A47J 31/407; A47J 31/0673

(57) ABSTRACT

A portafilter for use with an espresso coffee machine includes a handle, a receptacle, and a top cover. The receptacle has a void or reservoir that contains a single-use coffee cartridge (e.g., a K-CUP® cartridge). A bottom surface of the receptacle has needles directed into the void or reservoir which pierce a bottom surface of the cartridge, thereby creating holes in the bottom of the cartridge to allow liquid (e.g., hot coffee) to flow out of the cartridge. A hole in the bottom surface of the receptacle allows liquid hot coffee to flow out of the receptacle and into a coffee cup. The top cover includes tubular protrusions directed downward which pierce a top surface of the cartridge, thereby creating holes in the top surface of the cartridge to allow hot water from the espresso machine to flow through the tubes and into the top of the cartridge.

### FIELD OF THE INVENTION

The subject matter disclosed herein relates in general to apparatus for brewing coffee, and more specifically to a multi-use portafilter for an espresso machine in which the portafilter is adapted for use with a common type of a single-use cartridge containing dry ground coffee to brew the coffee contained in the cartridge.

### BACKGROUND OF THE INVENTION

Single-use or single-serve coffee cartridges are well-known, ubiquitous, and very convenient for someone who desires to brew only a single cup of coffee or other hot beverage such as tea or hot cocoa/hot chocolate at any one time. A predetermined amount of the dry ground coffee, tea or other beverage or non-beverage material that can be prepared or brewed by dripping is contained within the sealed, air-tight plastic or aluminum cartridge. The cartridge protects the dry ground coffee from the environment (e.g., sunlight, oxygen, humidity, temperature), thereby keeping it fresh and aromatic for a relatively long period of time. When in use, pressurized hot water is injected into the cartridge at an opening formed at one end (i.e., the aluminum foil seal end typically at the top of the cartridge) during the start of the brewing process. The water then mixes with and passes through the dry ground coffee in the cartridge, thereby absorbing its constituent chemical compounds and extracting the coffee flavor (i.e., brews the coffee). The hot liquid coffee flows through an internal paper filter and out of an opening formed at the opposite end of the cartridge (i.e., the bottom) and into a receiving cup or other vessel.

These single-serve coffee cartridges (aka capsules, pods, or pads) typically require a corresponding dedicated coffee brewing machine to be able to brew a cup of coffee from one of these cartridges. The originator of the single-serve coffee cartridges and associated machines was Keurig, Inc. in the 1990's. Keurig's cartridges are well-known as the K-CUP® cartridges. See, e.g., U.S. Pat. No. 5,325,765. There are many commercial manufacturers and providers today of K-CUP® cartridges and dedicated brewing machines for both home use and business or office use. These K-CUP® cartridge brewing machines are generally easy to use and require little to no clean up afterwards. Also, the K-CUP® cartridge brewing machine typically allows the user to vary the amount of coffee in fluid ounces that is brewed with a cartridge at any one time. Further, the commercially available K-CUP® cartridges sold today contain nearly every type and flavor of coffee available, which contributes to their enormous popularity worldwide.

Espresso coffee is known as a type of coffee that is generally bolder in flavor than regular coffee, due to it being higher in caffeine concentration (e.g., on average 4 to 5 times higher) as a result of the brewing process. Espresso is typically brewed using a finer grind of coffee and a greater coffee grounds-to-water ratio than regular coffee. This also results in espresso being slightly thicker in consistency than regular coffee.

Similar to regular coffee brewed by the K-CUP® cartridge brewing machine, espresso coffee machines are also commercially available that utilize single-cup or single-serve cartridges which brew a single cup of espresso at a time. See, for example, the NESPRESSO® cartridges provided by Nestle. See also, e.g., U.S. Pat. No. 4,136,202. These espresso machines use a portafilter or portaholder device, which comprises a handle and a basket that holds the dry ground coffee contained either in a single-serve cartridge or directly placed and tamped into the basket without a cartridge. The portafilter is then placed into the brew head or “group” of the espresso machine for brewing similar to regular coffee in that pressurized hot water is mixed with and passed through the dry ground coffee in the basket.

A portafilter can have various different features such as constituent materials, a spout, along with different diameters of the basket. These basket diameters typically range from 49 mm to 58 mm, although other diameter sizes are available. Thus, the incompatibility of portafilters between different manufacturers of espresso machines sometimes becomes an issue. Even portafilters from different manufacturers having baskets of the same diameter may not be compatible with one another.

Noted also is that the outer diameter size of the K-CUP® cartridge differs relatively significantly from the outer diameter size of the NESPRESSO® cartridge. The outer diameter of the K-CUP® cartridge tapers downward from a larger diameter of approximately 51 mm (2 inches) at the top of the cartridge to a smaller diameter of approximately 38 mm (1.5 inches) at the bottom of the cartridge. The height of the K-CUP® cartridge is approximately 38 mm (1.5 inches).

In contrast, the outer diameter of the NESPRESSO® cartridge tapers downward from a larger diameter of approximately 37 mm at the top of the cartridge to a smaller diameter of approximately 24 mm at the bottom of the cartridge. The height of the NESPRESSO® cartridge is approximately 29 mm. As such, these two brands of cartridges are incompatible with one another due in part to the different diameter and height sizes. Nevertheless, it is oftentimes desirable to be able to use an espresso machine to brew coffee contained in a K-CUP® cartridge. This would provide a viable alternative to the strict requirement of needing a K-CUP® brewer to brew coffee in a K-CUP® cartridge. However, heretofore, this has generally not been possible.

Therefore, what is needed is a multi-use portafilter that is adapted for use with a K-CUP® cartridge to brew the dry ground coffee contained in the K-CUP® cartridge in an espresso machine. Further, what is also needed is that the same multi-use portafilter is adapted to have an insert which allows the portafilter to utilize the smaller size (i.e., diameter and height) NESPRESSO® espresso coffee cartridge.

### BRIEF SUMMARY OF THE INVENTION

An object of embodiments of the present invention is to provide a multi-use portafilter for use with an espresso coffee machine wherein the portafilter is adapted in size to hold a single-serve K-CUP® cartridge having dry ground coffer therein for subsequent brewing into hot liquid coffee by the espresso coffee machine.

Another object of embodiments of the present invention is to provide a multi-use portafilter for use with an espresso coffee machine wherein the portafilter is adapted in size to hold a single-serve K-CUP® cartridge having dry ground coffer therein and is also adapted for alternative use with an insert placed in the portafilter so as to be adapted to hold a smaller size (i.e., diameter and height) single-serve NESPRESSO® cartridge for subsequent brewing into hot liquid coffee by the espresso coffee machine.

Yet another object of embodiments of the present invention is to provide a multi-use portafilter for use with an espresso coffee machine wherein the portafilter is adapted in size to hold a paper filter which contains an amount of dry ground coffee that is placed within the paper filter for subsequent brewing into hot liquid coffee by the espresso coffee machine.

Still another object of embodiments of the present invention is to provide a multi-use portafilter for use with an espresso coffee machine which eliminates the need for a dedicated coffee brewing machine that is only sized to receive and operate with a single-serve K-CUP® cartridge, thereby providing the new-found ability to use K-CUP® cartridges with espresso coffee machines.

According to an embodiment of the present invention, a multi-use portafilter for use with an espresso coffee machine includes a handle and a receptacle disposed at an end of the handle, and a top cover that covers a top portion of the receptacle. The handle facilitates the manual insertion and removal of the portafilter with respect to a brew head of the espresso coffee machine. The receptacle has a void or reservoir that contains or houses a single-use coffee cartridge (e.g., a K-CUP® cartridge) when in use. A bottom surface of the receptacle includes one or more protrusions (e.g., sharpened spikes) that are directed upward into the void or reservoir and are operable to pierce a bottom surface of the cartridge, thereby creating a corresponding one or more holes in the bottom of the cartridge to allow liquid (e.g., hot coffee) to flow out of the bottom of the cartridge. A hole is formed in the bottom surface of the receptacle to allow the liquid to flow out of the receptacle and into a receiving vessel (e.g., a coffee cup or mug). The top cover includes one or more tubular protrusions having sharp edges and which are directed downward into the void or reservoir. These tubes are operable to pierce a top surface of the cartridge, thereby creating a corresponding one or more holes in the top surface of the cartridge to allow liquid (e.g., pressurized hot water) provided by the espresso machine to flow through the tubes and into the top of the cartridge. The top cover also includes a handle that interfaces with the handle of the portafilter and facilitates the physical placement of the top cover with respect to the portafilter.

According to another embodiment of the present invention, the portafilter further includes an insert that is placed within the void or reservoir of the receptacle of the portafilter. The insert includes a receptacle having a void or reservoir that is operable to receive a single-serve cartridge which is smaller in diameter and height than the diameter and height of the single-serve cartridge that is placed within the portafilter receptacle. A bottom surface of the receptacle of the insert includes one or more protrusions (e.g., sharpened spikes) that are directed upward into the void or reservoir of the insert and are operable to pierce a bottom surface of the cartridge, thereby creating a corresponding one or more holes in the bottom of the cartridge to allow liquid (e.g., hot coffee) to flow out of the bottom of the cartridge. A hole is formed in the bottom surface of the receptacle of the insert to allow the liquid to flow out of both the receptacle of the insert and the receptacle of the portafilter and into a receiving vessel (e.g., a coffee cup or mug). The top cover of the portafilter is placed over the insert to thereby cover both the insert and the receptacle in the portafilter. The top of the insert includes a flange that rests on a top surface of the receptacle of the portafilter. The size of the insert allows for a single-serve cartridge such as a NESPRESSO® cartridge that is smaller in diameter and height than a K-CUP® cartridge to bs used with the portafilter of the present invention.

According to yet another embodiment of the present invention, a portafilter for use with an espresso coffee machine includes a handle and a receptacle disposed at an end of the handle. The receptacle has a void or reservoir that contains or houses a paper filter, a portion of which may wrap around or over and otherwise attach to an upper outer surface (e.g., rim) of the receptacle. A bottom surface of the receptacle includes a basket style mesh filter with openings that allow liquid (e.g., hot coffee) to flow out of the bottom of the receptacle and into a receiving vessel (e.g., a coffee cup or mug). In contrast to previously described embodiments of the portafilter of the present invention, no top cover or insert is utilized with this embodiment. In use, an amount of dry ground coffee is placed into the paper filter for brewing. The dry ground coffee may be tamped down to facilitate brewing. Pressurized hot water is flowed from the espresso coffee machine and into the top portion of the receptacle where it then flows downward and into and through the dry ground coffee, thereby brewing the coffee. The resulting brewed liquid hot coffee then flows out of the bottom of the receptacle and into a receiving vessel (e.g., a coffee cup or mug).

### BRIEF DESCRIPTION OF THE DRAWINGS

The subject matter, which is regarded as the disclosure herein of exemplary embodiments of the present invention, is particularly pointed out and distinctly claimed in the claims at the conclusion of this specification. The forgoing and other features and advantages of the present invention will become more apparent from the following detailed description taken in conjunction with the accompanying drawings in which:

FIG. 1 is an exploded side elevation view of a multi-use portafilter having a handle integrated with a receptacle and also having a top cover, and showing a K-CUP® cartridge between the handle and the top cover, according to a first embodiment of the present invention;

FIG. 2 is an exploded view, taken from the top, of the multi-use portafilter of FIG. 1;

FIG. 3 is an exploded view, taken from the bottom, of the multi-use portafilter of FIG. 1;

FIG. 4 is a perspective view, taken from the top, of an insert for use with the multi-use portafilter of FIGS. 1-3, according to a second embodiment of the present invention;

FIG. 5 is an exploded view, taken from the bottom, of the insert of FIG. 4 utilized with the multi-use portafilter of FIGS. 1-3; and

FIG. 6 is an exploded side elevation view of a paper filter for use with the multi-use portafilter of FIGS. 1-3, according to a third embodiment of the present invention.

### DETAILED DESCRIPTION OF THE INVENTION

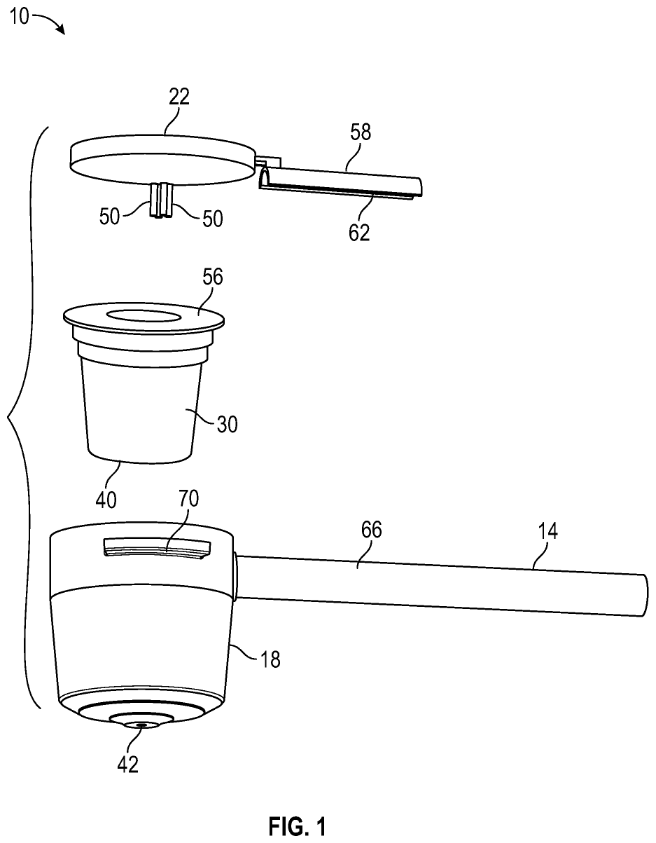

Referring to FIGS. 1-3, there illustrated is a multi-use portafilter 10 according to a first exemplary embodiment of the present invention. The portafilter 10 is configured for use with an espresso coffee machine (not shown). The portafilter 10 includes a handle 14 and a receptacle 18 disposed along a length of the handle 14; for example, at an end of the handle 14. The portafilter also includes a top cover 22 that covers a top portion of the receptacle 18. The handle 14 facilitates the manual insertion and removal of the portafilter 10 with respect to a brew head of the espresso coffee machine. The receptacle 18 has a reservoir or void 26 that contains a single-use or single-serve coffee cartridge 30 (e.g., a K-CUP® cartridge 30) when the portafilter 10 is in use and is operable to the brew dry ground coffee within the K-CUP® cartridge 30. Typically, the K-CUP® cartridge has a predetermined amount of dry ground coffee therein.

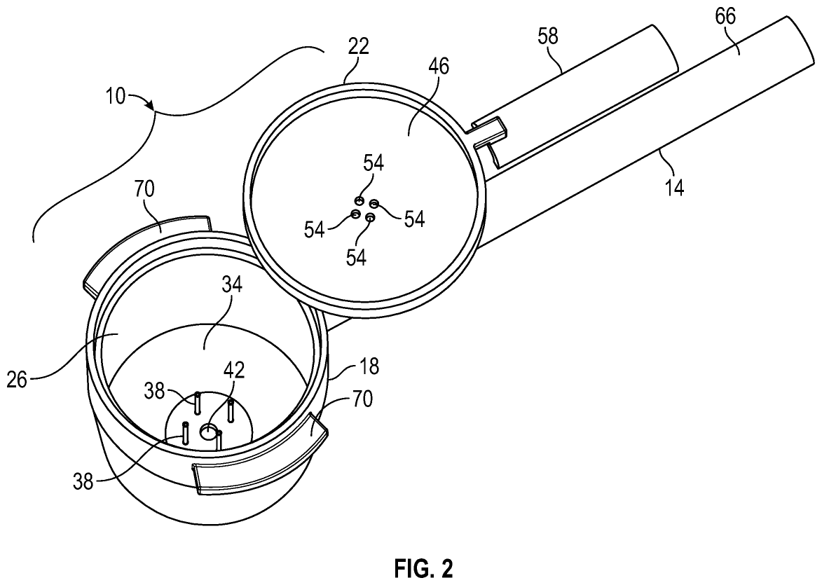

A bottom surface 34 of the receptacle 18 on the inside of the void or reservoir 26 includes one or more protrusions 38 (e.g., sharpened needles 38) directed upward into the void or reservoir 26, as best seen in FIG. 2. The protrusions 38 are configured and operable to pierce a bottom surface 40 of the cartridge 30, thereby creating a corresponding one or more holes in the bottom surface 40 of the cartridge 30 to allow liquid (e.g., hot coffee) to flow out of the bottom surface 40 of the cartridge 30. A hole 42 is formed in the bottom surface 34 of the receptacle 18 to allow the liquid to flow out of the receptacle 18 and into a receiving vessel (e.g., a coffee cup or mug—not shown).

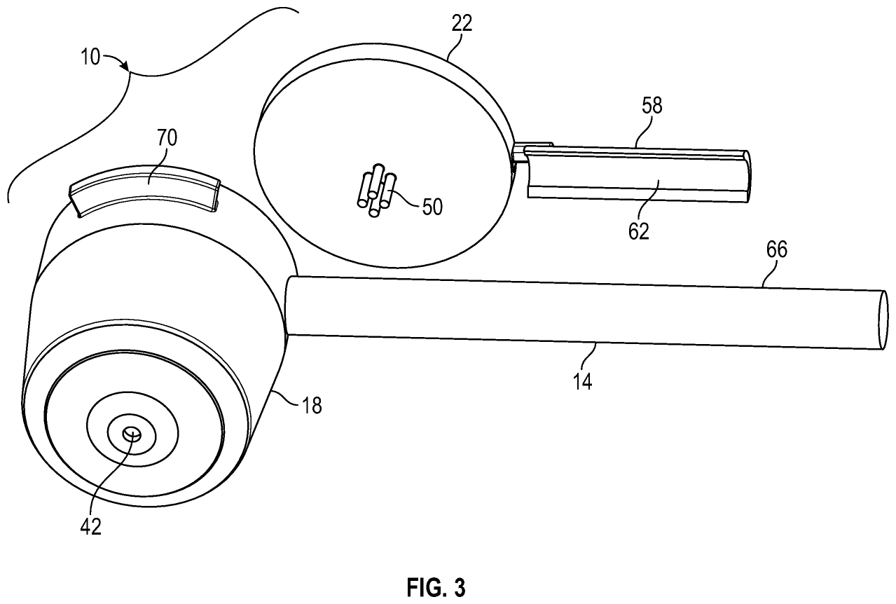

The top cover 22 has a concave downward protruding surface 46 which facilitates the capture and steering of pressurized hot water from the espresso machine during a brew cycle. As best seen in FIG. 3, the top cover 22 also includes one or more tubular protrusions (e.g., needles) or tubes 50 having sharp edges and which are directed downward from the surface 46 and into the void or reservoir 26 of the receptacle 18 when the top cover 22 is placed onto the top portion of the receptacle 18. Each tubular protrusion 50 interfaces with a corresponding hole 54 formed in the surface 46 to provide a continuous flow path therethrough for liquid (e.g., pressurized hot water). The tubular protrusions 50 are configured and operable to pierce a top surface 56 of the cartridge 30, thereby creating a corresponding one or more holes in the top surface 56 of the cartridge 30. This allows liquid (e.g., pressurized hot water) provided by the espresso machine to flow through the holes 54 down through the tubes 50 and into and through the holes formed in the top surface 56 of the cartridge 30 and into the cartridge 30 for brewing of the dry ground coffee or other substance (e.g., tea, hot cocoa/hot chocolate, etc.) contained within the cartridge 30.

The top cover 22 also includes a handle 58 having a concave inner surface 62 that interfaces and connects with a convex outer surface 66 of the portafilter handle 14. The handle 14 facilitates the manual physical placement and proper location of the top cover 22 with respect to the receptacle 18 of the portafilter 10. The receptacle 18 may include one or more flanges 70 attached to an upper outer surface of the receptacle 18 near the top thereof. The various components 14, 18, 22 of the portafilter 10 may comprise a metal or plastic material or other suitable materials alone or in combination.

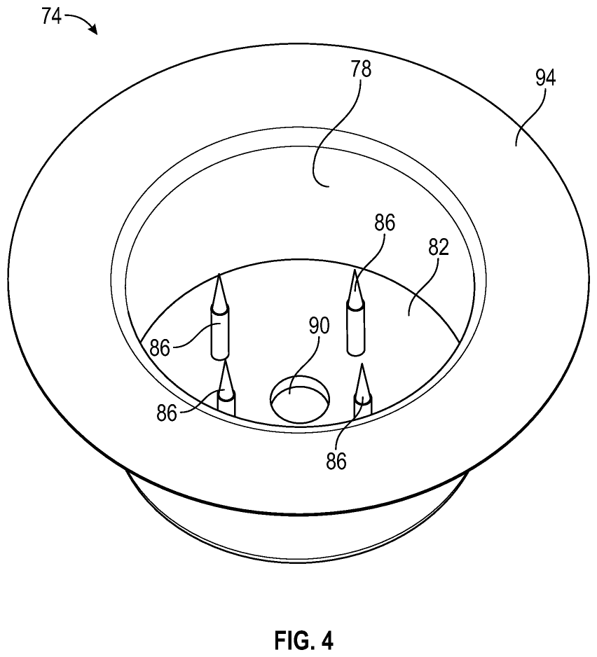

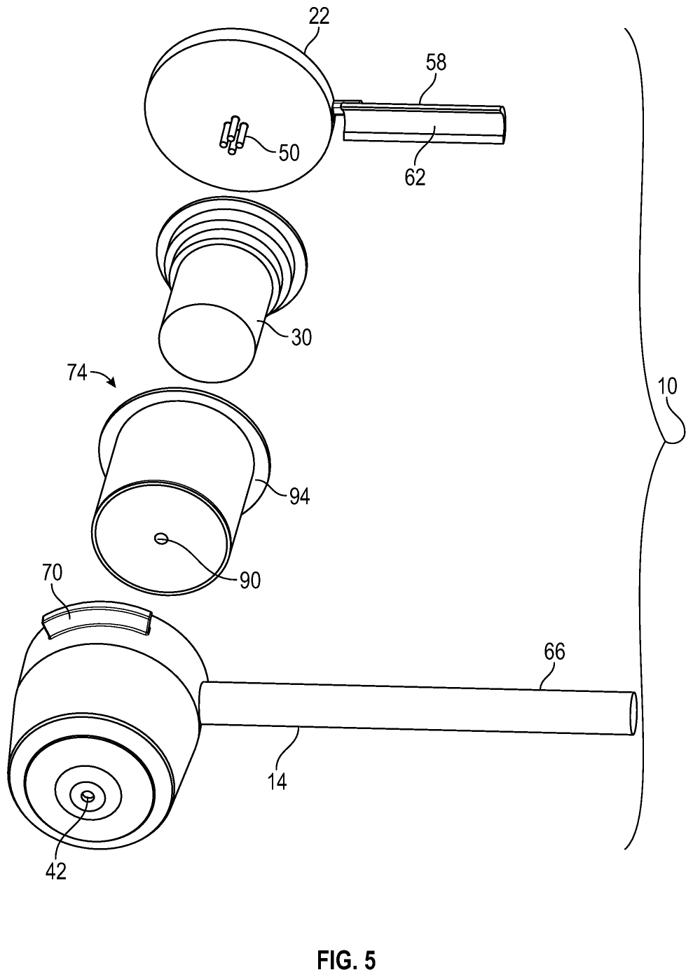

Referring to FIGS. 4 and 5, there illustrated is a second exemplary embodiment of the multi-use portafilter 10 of the present invention. In this embodiment, the portafilter 10 is similar to the embodiment described hereinabove and illustrated in FIGS. 1-3. However, this second exemplary embodiment further includes an insert 74 that is placed within the void or reservoir 26 of the receptacle 18 of the portafilter 10. The insert 74 includes a void or reservoir 78 of its own that is configured and operable to receive a single-serve cartridge 30 such as a NESPRESSO® espresso coffee cartridge 30. The NESPRESSO® cartridge 30 is generally similar in shape to the K-CUP® cartridge 30. However, the NESPRESSO® cartridge 30 is smaller in both diameter and height than the K-CUP® cartridge 30, which is placed directly within the portafilter receptacle 18 as described hereinabove and illustrated in FIGS. 1-3. Thus, the insert 74 of this second exemplary embodiment of the multi-use portafilter 10 of the present invention is configured and operable to accommodate the smaller size NESPRESSO® cartridge 30 within the portafilter 10.

A bottom surface 82 in the void or reservoir 78 of the insert 74 includes one or more protrusions 86 (e.g., sharpened needles 86) that are directed upward into the void or reservoir 78. The protrusions 86 are configured and operable to pierce a bottom surface 40 of the cartridge 30, thereby creating a corresponding one or more holes in the bottom surface 40 of the cartridge 30 to allow liquid (e.g., hot coffee) to flow out of the bottom surface 40 of the cartridge 30. A hole 90 formed in the bottom surface 82 of the insert 74 allows the liquid to flow out of both the insert 74 and the receptacle 18 of the portafilter 10 and into a receiving vessel (e.g., a coffee cup or mug).

In use, the top cover 22 of the portafilter 10 is placed over the insert 74 to thereby cover the insert 74, the cartridge 30 contained in the insert 74, and the receptacle 18 of the portafilter 10. The top portion of the insert 74 includes a flange 94 that encircles a portion or all of the outer circumference of the insert 74. As such, the flange 94 may rest on a top surface of the receptacle 18 of the portafilter 10. The size of the insert 74 allows for a single-serve cartridge 30 such as a NESPRESSO® cartridge 30 that is smaller in diameter and height than a K-CUP® cartridge 30 to be used with the portafilter 10 of embodiments of the present invention. Also, the depth of the insert 74 as it sits within the receptacle 18 of the portafilter 10 may be such that the bottom surface 82 of the insert 74 does not contact the protrusions 38 on the bottom surface 34 of the receptacle 18 of the portafilter 10.

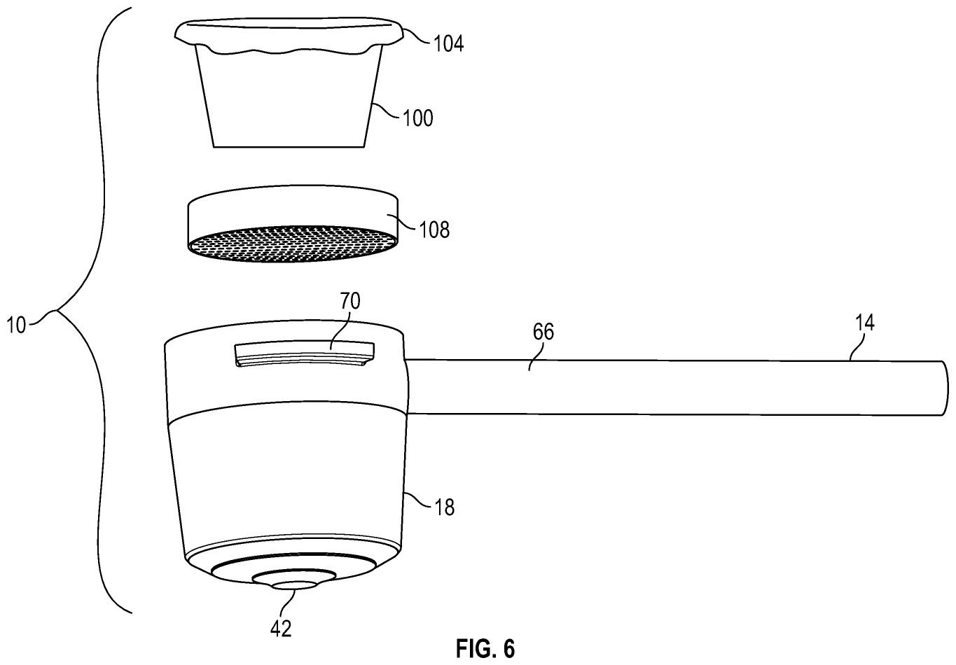

Referring to FIG. 6, there illustrated is a third exemplary embodiment of the multi-use portafilter 10 of the present invention. In this embodiment, the receptacle 18 of the portafilter 10 is configured and is operable to contain or hold in place a paper filter 100. Although not shown, a portion 104 of the paper filter 100 may wrap around and over, or otherwise attach to, an upper outer surface (e.g., rim) of the receptacle 100, for example, in the area of the flanges 70. A basket-style mesh filter 108 may be included which may be placed at the bottom of the void or reservoir 26 within the receptacle 18. The mesh filter 108 has a plurality of openings which allow liquid (e.g., hot coffee) to pass through and to and through the hole 42 in the bottom surface 34 of the receptacle 18.

In contrast to the embodiments of the portafilter 10 of the present invention described hereinabove and illustrated in FIGS. 1-5, no top cover 22 or insert 74 is utilized with this embodiment illustrated in FIG. 6. Also, no protrusions 38 are needed inside the receptacle 18 of the portafilter 10.

In use, an amount of dry ground coffee is placed into the paper filter 100 for brewing. The dry ground coffee may then be tamped down or compacted. Pressurized hot water is then flowed from the espresso coffee machine and into the top portion of the receptacle 18 where it flows downward and into and through the dry ground coffee within the filter 100, thereby brewing the coffee. The resulting brewed liquid hot coffee then flows out of the hole 42 in the bottom surface 34 of the receptacle 18 and into a receiving vessel (e.g., a coffee cup or mug).

Exemplary embodiments of the multi-use portafilter 10 of the present invention allow for the use of the portafilter 10 with a traditional espresso coffee machine, which thereby eliminates the need for a dedicated K-CUP® coffee brewing machine that is only sized to receive and operate with a single-serve K-CUP® cartridge 30.

The terminology used herein is for the purpose of describing particular embodiments of the invention only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention is provided in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that the exemplary embodiments may include only some of the described exemplary aspects. Accordingly, the invention it not to be seen as limited by the foregoing description but is only limited by the scope of the appended claims.

1. A multi-use portafilter for use with an espresso coffee machine, comprising:
a handle configured and operable to facilitate manual placement of the portafilter with respect to the espresso coffee machine;
a receptacle disposed along a length of the handle, the receptacle having a reservoir configured and operable to contain a first cartridge therewithin, the first cartridge having a predetermined size, the receptacle having a bottom surface that includes one or more protrusions directed upward into the reservoir, each of the receptacle protrusions being configured and operable to pierce a bottom surface of the first cartridge thereby creating a corresponding one or more holes in a bottom of the first cartridge that are each configured and operable to allow liquid to flow out of the bottom of the first cartridge, the receptacle having a hole formed in a bottom surface of the receptacle that is configured and operable to allow the liquid to flow out of the receptacle and into a receiving vessel; and
a top cover configured and operable to cover the reservoir of the receptacle, the top cover including one or more tubular protrusions directed downward into the reservoir, each of the tubular protrusions being configured and operable to pierce a top surface of the first cartridge thereby creating a corresponding one or more holes in the top surface of the first cartridge, each of the holes being configured and operable to allow liquid provided by the espresso machine to flow through the tubular protrusions and into the top of the first cartridge.

2. The multi-use portafilter of claim 1, wherein the predetermined size of the first cartridge includes a first diameter and a first height.

3. The multi-use portafilter of claim 1, wherein the first cartridge comprises a K-CUP® cartridge.

4. The multi-use portafilter of claim 1, wherein the first cartridge comprises a single-serve coffee cartridge having an amount of dry ground coffee therein.

5. The multi-use portafilter of claim 1, further comprising an insert configured to be disposed within the receptacle of the portafilter.

6. The multi-use portafilter of claim 5, wherein the insert includes a receptacle having a reservoir configured and operable to contain a second cartridge therewithin.

7. The multi-use portafilter of claim 6, wherein the receptacle of the insert comprises a bottom surface that includes one or more protrusions directed upward into the reservoir of the insert, each of the insert protrusions being configured and operable to pierce a bottom surface of the second cartridge thereby creating a corresponding one or more holes in a bottom of the second cartridge to allow liquid to flow out of the bottom of the second cartridge and through the hole in the bottom surface of the receptacle of the portafilter and into a receiving vessel.

8. The multi-use portafilter of claim 6, wherein the top cover is configured and operable to cover the reservoir of the receptacle of the insert.

9. The multi-use portafilter of claim 8, wherein the one or more tubular protrusions of the top cover are directed downward into the reservoir of the insert, the one or more tubular protrusions of the top cover being configured and operable to pierce a top surface of the second cartridge thereby creating a corresponding one or more holes in the top surface of the second cartridge to allow liquid provided by the espresso machine to flow through the tubular protrusions and into the top of the second cartridge.

10. The multi-use portafilter of claim 5, wherein the second cartridge has a predetermined size that includes a second diameter and a second height, the second diameter being smaller than the first diameter, the second height being smaller than the first height.

11. The multi-use portafilter of claim 5, wherein the second cartridge comprises a NESPRES SO® cartridge.

12. The multi-use portafilter of claim 1, wherein the receptacle is disposed at an end of the handle.

13. The multi-use portafilter of claim 1, wherein the top cover further comprises a handle portion that interfaces with the handle of the portafilter.

14. A portafilter for use with an espresso coffee machine, comprising:
a handle configured and operable to facilitate manual placement of the portafilter with respect to the espresso coffee machine;
a receptacle disposed along a length of the handle, the receptacle having a reservoir;
an insert configured to be disposed within the reservoir of the receptacle, the insert having a void configured and operable to contain a cartridge therewithin, the insert having a bottom surface that includes one or more protrusions directed upward into the void, the protrusions being configured and operable to pierce a bottom surface of the cartridge thereby creating a corresponding one or more holes in a bottom of the cartridge to allow liquid to flow out of the bottom of the cartridge, the receptacle having a hole formed in a bottom surface of the receptacle and configured and operable to allow the liquid to flow out of the receptacle and into a receiving vessel; and
a top cover configured and operable to cover both the insert and the receptacle, the top cover including one or more tubular protrusions directed downward into the void, the tubular protrusions being configured and operable to pierce a top surface of the cartridge thereby creating a corresponding one or more holes in the top surface of the cartridge, each of the holes being configured and operable to allow liquid provided by the espresso machine to flow through the tubular protrusions and into the top of the cartridge, the top cover having a handle portion that interfaces with the handle of the portafilter and facilitates the manual physical placement of the top cover with respect to the portafilter.

15. The portafilter of claim 14, wherein the receptacle is disposed at an end of the handle.

16. The portafilter of claim 14, wherein the cartridge comprises a single-serve coffee cartridge having an amount of dry ground coffee therein.

17. The portafilter of claim 16, wherein the single-serve cartridge comprises a NESPRES SO® cartridge.

18. A portafilter for use with an espresso coffee machine, comprising:
a handle configured and operable to facilitate manual placement of the portafilter with respect to the espresso coffee machine; and
a receptacle disposed along a length of the handle, the receptacle having a reservoir configured and operable to contain a first filter and a second filter, the first filter being configured and operable to hold a predetermined amount of dry ground coffee, the second filter being configured and operable filter a liquid flowing through and out of the first filter, the receptacle having a bottom surface that includes at least one hole formed therein configured and operable to allow liquid to flow out of the receptacle and into a receiving vessel.

19. The portafilter of claim 18, wherein the first filter comprises a paper filter that is configured and operable to hold a predetermined amount of dry ground coffee therein.

20. The portafilter of claim 19, wherein the second filter includes a plurality of holes that are configured in size and operable to pass the liquid therethrough.
